(19) United States
(12) Patent Application Publication
(10) Pub. No.: US 2015/0103945 A1
(43) Pub. Date: Apr. 16, 2015

(54) SIGNAL CONVERSION DEVICE AND TRANSMITTER

(71) Applicant: SUMITOMO ELECTRIC INDUSTRIES, LTD., Osaka-shi, Osaka (JP)

(72) Inventor: Takashi Maehata, Osaka-shi (JP)

(21) Appl. No.: 14/401,878

(22) PCT Filed: May 31, 2013
(86) PCT No.: PCT/JP2013/065143

§ 371 Date: Nov. 18, 2014

(30) Foreign Application Priority Data
Jun. 5, 2012 (JP) 2012-127615

(51) Int. Cl. H04L 25/02

(52) U.S. Cl. CPC H04L 25/02
USPC 375/295

(57) ABSTRACT

A signal conversion device includes: a converter configured to output a 1-bit quantized signal representing an analog signal based on a band transmission system; and an encoder configured to execute a baseband line coding process on the 1-bit quantized signal. The baseband line coding process is a process to be frequency conversion for the analog signal, and is a baseband line coding process in which the 1-bit quantized signal is coded such that the appearance frequencies of two kinds of bit values in the 1-bit quantized signal are different from each other.

### TECHNICAL FIELD

The present invention relates to signal conversion devices and transmitters.

### BACKGROUND ART

Delta-sigma modulation is an example of a technique of generating a 1-bit pulse train representing an analog waveform (refer to Non-Patent Literature 1).

### CITATION LIST

### Non Patent Literature

NON PATENT LITERATURE 1: Takao Waho and Akira Yasuda (translation supervisors) (Original authors: Richard Schreier, Gabor C. Temes), “Understanding Delta-Sigma Data Converters”, Maruzen Co., Ltd., 2007, pp. 1-17

### SUMMARY OF INVENTION

### Technical Problem

It is desired that a baseband line coding technique is applied to a 1-bit quantized signal representing an analog signal based on a band transmission system, and simultaneously, influence of the baseband line coding on the analog signal based on the band transmission system is suppressed as much as possible.

It is an object to apply a baseband line coding technique to a 1-bit quantized signal representing an analog signal based on a band transmission system, and simultaneously, suppress influences of the baseband line coding on the analog signal based on the band transmission system as much as possible.

### Solution to Problem

The present invention relates to a signal conversion device including: a converter configured to output a 1-bit quantized signal representing an analog signal based on a band transmission system; and an encoder configured to execute a baseband line coding process on the 1-bit quantized signal. The baseband line coding process is a process to be frequency conversion for the analog signal, and is a baseband line coding process in which the 1-bit quantized signal is coded such that the appearance frequencies of two kinds of bit values in the 1-bit quantized signal are different from each other.

Another aspect of the present invention relates to a signal conversion device including: a converter configured to output a 1-bit quantized signal representing an analog signal based on a band transmission system; and an encoder configured to execute a baseband line coding process on the 1-bit quantized signal. The encoder includes a lookup table in which a line coded value corresponding to each of two kinds of bit values in the 1-bit quantized signal is defined, and executes the baseband line coding process based on the lookup table.

Still another aspect of the present invention relates to a signal conversion device, including: a converter configured to output a 1-bit quantized signal representing an analog signal based on a band transmission system; and an encoder configured to execute a baseband line coding process on the 1-bit quantized signal. The converter is configured to output the 1-bit quantized signal in parallel. The encoder is configured to execute the baseband line coding process on the parallel 1-bit quantized signal, and includes a parallel-to-serial converter configured to convert the parallel signal having been subjected to the baseband line coding process into a serial signal, and output the serial signal.

The present invention can be implemented not only as such a characteristic signal conversion device but also as a method including, as steps, the characteristic processes performed by the signal conversion device, or as a program causing a computer to execute the steps. In addition, the present invention can be implemented as a semiconductor integrated circuit implementing a part or the entirety of the signal conversion device, or as a system including the signal conversion device. Further, the program can be stored in a recording medium such as a CD-ROM.

### Advantageous Effects of Invention

According to the present invention, a baseband line coding technique can be applied to a 1-bit quantized signal representing an analog signal based on a band transmission system, and simultaneously, influence of the baseband line coding on the analog signal based on the band transmission system can be suppressed as much as possible.

### BRIEF DESCRIPTION OF DRAWINGS

FIG. 1 is a block diagram showing a system (transmitter) including a signal conversion device.

FIG. 2 is a block diagram showing a delta-sigma modulator.

FIG. 3 shows a first-order low-pass delta-sigma modulator.

FIG. 4 shows a second-order band-pass delta-sigma modulator obtained through conversion of the first-order low-pass delta-sigma modulator.

FIG. 5 is a block diagram showing a device used for simulation.

FIG. 6 is a waveform diagram showing a symmetric waveform.

FIG. 7 is a waveform diagram showing an asymmetric waveform.

FIG. 8 is a diagram for explaining simulation parameters.

FIG. 9 shows a power spectrum of a symmetric waveform.

FIG. 10 shows a power spectrum of an asymmetric waveform.

FIG. 11 is a diagram showing measurement results.

FIG. 12 is a diagram for explaining RZ coding and frequency conversion.

FIG. 13 is a diagram for explaining Manchester coding and frequency conversion.

FIG. 14 is a diagram for explaining a mixer.

FIG. 15(a) shows a spectrum of an output of a band-pass delta-sigma modulator, FIG. 15(b) shows a spectrum of a signal obtained by RZ-coding the output of the band-pass delta-sigma modulator, and FIG. 15(c) shows a spectrum of a signal obtained by Manchester-coding the output of the band-pass delta-sigma modulator.

FIG. 16 is a diagram showing a first example of an encoder.

FIG. 17 is a diagram showing a second example of the encoder.

FIG. 18 is a diagram showing a third example of the encoder.

FIG. 19 is a diagram showing a fourth example of the encoder.

### DESCRIPTION OF EMBODIMENTS

### Summary of Embodiment

Delta-sigma modulation is a kind of oversampling modulation. A delta-sigma modulator is configured to include a loop filter and a quantizer. The quantizer can output a 1-bit pulse train as a quantized signal.

The 1-bit pulse train output from the delta-sigma modulator is restored to the original analog waveform by simply being passed through an analog filter. In other words, the 1-bit pulse train output from the delta-sigma modulator is a digital signal, but represents an analog waveform, and therefore, has the properties of both a digital signal and an analog signal.

The 1-bit quantized signal is a pulse train having a value of 0 or 1. In the 1-bit pulse train, the pulse waveform may vary between a case where 1 is output immediately after consecutive 0s or a case where 0 is output immediately after consecutive 1s, and a case where 0s and 1s are alternately output. The number of consecutive 0s or 1s is referred to as a run length.

When the run length is increased, charging is performed on a parasitic capacitance in a digital circuit generating the pulse waveform, an AC coupling capacitor between circuits, and the like. Therefore, discharging is started at the instant when another signal (1 or 0) is attempted to be output after consecutive 0s or 1s, and a current flow occurs in a different manner from the case where 0s and 1s are alternately output. Therefore, when another signal is generated after consecutive 0s or 1s, abnormal waveform distortion occurs.

Accordingly, the run length is desired to be small in terms of suppressing such distortion in the pulse waveform.

The problem of the distortion in the pulse waveform caused by the large run length has conventionally been known for the baseband transmission system using no carrier wave. In the baseband transmission system, a baseband line coding technique has been adopted as a countermeasure to such a problem.

However, it has never been considered as to whether distortion in a pulse waveform becomes a problem in a 1-bit quantized signal representing an analog signal (modulated wave) based on a band transmission system using a carrier wave.

The inventor of the present invention has discovered for the first time that, in a 1-bit quantized signal representing an analog signal (modulated wave) based on the band transmission system using a carrier wave, distortion in a pulse waveform adversary affects signal characteristics of the analog signal.

So, the inventor of the present invention has found that it is preferable to apply the baseband line coding technique also to a 1-bit quantized signal representing an analog signal (modulated wave) based on the band transmission system, in order to suppress the distortion in the pulse waveform. However, it is also desired to suppress as much as possible influence of the baseband line coding on the analog signal based on the band transmission system.

Hereinafter, the content of the embodiment will be described in accordance with lists (1) to (12) below.

(1) A signal conversion device according to the embodiment includes: a converter configured to output a 1-bit quantized signal representing an analog signal based on a band transmission system; and an encoder configured to execute a baseband line coding process on the 1-bit quantized signal. The baseband line coding process is a process to be frequency conversion for the analog signal, and is a baseband line coding process in which the 1-bit quantized signal is coded such that the appearance frequencies of two kinds of bit values in the 1-bit quantized signal are different from each other.

According to the above configuration, the 1-bit quantized signal representing the analog signal based on the band transmission system is subjected to the baseband line coding process. The baseband line coding process is a process to be frequency conversion for the analog signal, whereby the spectrum of the analog signal is preserved merely with the frequency of the analog signal being converted. Further, the 1-bit quantized signal is coded such that the appearance frequencies of the two kinds of bit values in the 1-bit quantized signal are different from each other, whereby a low frequency component including a DC component of the analog signal is prevented from being suppressed.

(2) Preferably, the encoder is able to execute a first baseband line coding process on the 1-bit quantized signal and a second baseband line coding process on the 1-bit quantized signal by selectively switching between these coding processes. The first baseband line coding process is a process to be frequency conversion for the analog signal, and is a baseband line coding process in which the 1-bit quantized signal is coded such that the appearance frequencies of two kinds of bit values in the 1-bit quantized signal are different from each other. The second baseband line coding process is a process to be frequency conversion for the analog signal, and is a baseband line coding process in which the 1-bit quantized signal is coded such that the appearance frequencies of two kinds of bit values in the 1-bit quantized signal are equal to each other.

In the second baseband line coding process in which coding is performed such that the appearance frequencies of the two kinds of bit values in the 1-bit quantized signal are equal to each other, the magnitude of the output varies depending on the frequency. Therefore, the magnitude of the output from the encoder can be varied by executing, in a selectively switching manner, the first baseband line coding process in which coding is performed such that the appearance frequencies of the two kinds of bit values in the 1-bit quantized signal are different from each other, and the second baseband line coding process.

(3) Preferably, the encoder executes the first baseband line coding process and the second baseband line coding process by selectively switching between these coding processes in accordance with the frequency of the analog signal. In this case, the appropriate baseband line coding process can be selected in accordance with the frequency.

(4) Preferably, the first baseband line coding process is an RZ coding process. The RZ coding process is a process to be frequency conversion for the analog signal, and is a baseband line coding process in which the 1-bit quantized signal is coded such that the appearance frequencies of the two kinds of bit values in the 1-bit quantized signal are different from each other.

(5) Preferably, the second baseband line coding process is a Manchester coding process. Manchester coding process is a process to be frequency conversion for the analog signal, and is a baseband line coding process in which the 1-bit quantized signal is coded such that the appearance frequencies of the two kinds of bit values in the 1-bit quantized signal are equal to each other.

(6) Preferably, the encoder includes a lookup table in which a line coded value corresponding to each of the two kinds of bit values in the 1-bit quantized signal is defined, and executes the baseband line coding process based on the lookup table. In this case, the coding process can be easily performed based on the lookup table.

(7) Preferably, the converter is configured to output the 1-bit quantized signal in parallel, and the encoder is configured to execute a baseband line coding process on the parallel 1-bit quantized signal, and includes a parallel-to-serial converter configured to convert the parallel signal having been subjected to the baseband line coding process into a serial signal, and output the serial signal In this case, the baseband line coding process can be performed in parallel.

(8) Preferably, the encoder includes a lookup table in which a line coded value corresponding to each of the two kinds of bit values in the 1-bit quantized signal is defined. In the lookup table, a plurality of line coded values are defined corresponding to each of the two kinds of bit values in the 1-bit quantized signal, and the encoder selects one of the plurality of line coded values defined corresponding to each of the two kinds of bit values in the 1-bit quantized signal to execute the baseband line coding process. In this case, in the lookup table, the plurality of line coded values are defined corresponding to each of the two kinds of bit values in the 1-bit quantized signal. Therefore, the encoder can select one of the plurality of transmission coded values defined corresponding to each of the two kinds of bit values in the 1-bit quantized signal to execute the baseband line coding process.

(9) A signal conversion device according to the embodiment includes: a converter configured to output a 1-bit quantized signal representing an analog signal based on a band transmission system; and an encoder configured to execute a baseband line coding process on the 1-bit quantized signal. The encoder includes a lookup table in which a line coded value corresponding to each of two kinds of bit values in the 1-bit quantized signal is defined, and executes the baseband line coding process, based on the lookup table.

According to this configuration, the coding process can be easily performed based on the lookup table.

(10) A signal conversion device according to the embodiment includes: a converter configured to output a 1-bit quantized signal representing an analog signal based on a band transmission system; and an encoder configured to execute a baseband line coding process on the 1-bit quantized signal. The converter is configured to output the 1-bit quantized signal in parallel. The encoder is configured to execute the baseband line coding process on the parallel 1-bit quantized signal, and includes a parallel-to-serial converter configured to convert the parallel signal having been subjected to the baseband line coding process into a serial signal, and output the serial signal.

According to this configuration, the baseband line coding process can be performed in parallel.

(11) Preferably, the encoder includes a lookup table in which a line coded value corresponding to each of the two kinds of bit values in the 1-bit quantized signal is defined. In the lookup table, a plurality of line coded values are defined corresponding to each of the two kinds of bit values in the 1-bit quantized signal, and the encoder selects one of the plurality of line coded values defined corresponding to each of the two kinds of bit values in the 1-bit quantized signal to execute the baseband line coding process. In this case, in the lookup table, the plurality of line coded values are defined corresponding to each of the two kinds of bit values in the 1-bit quantized signal. Therefore, the encoder can select one of the plurality of line coded values defined corresponding to each of the two kinds of bit values in the 1-bit quantized signal to execute the baseband line coding process.

(12) A transmitter according to the embodiment includes the signal conversion device described in any one of above (1) to (11), and transmits the 1-bit quantized signal having been subjected to the baseband line coding process

### Details of Embodiment

Hereinafter, the embodiment will be described with reference to the drawings.

[1. System Configuration]

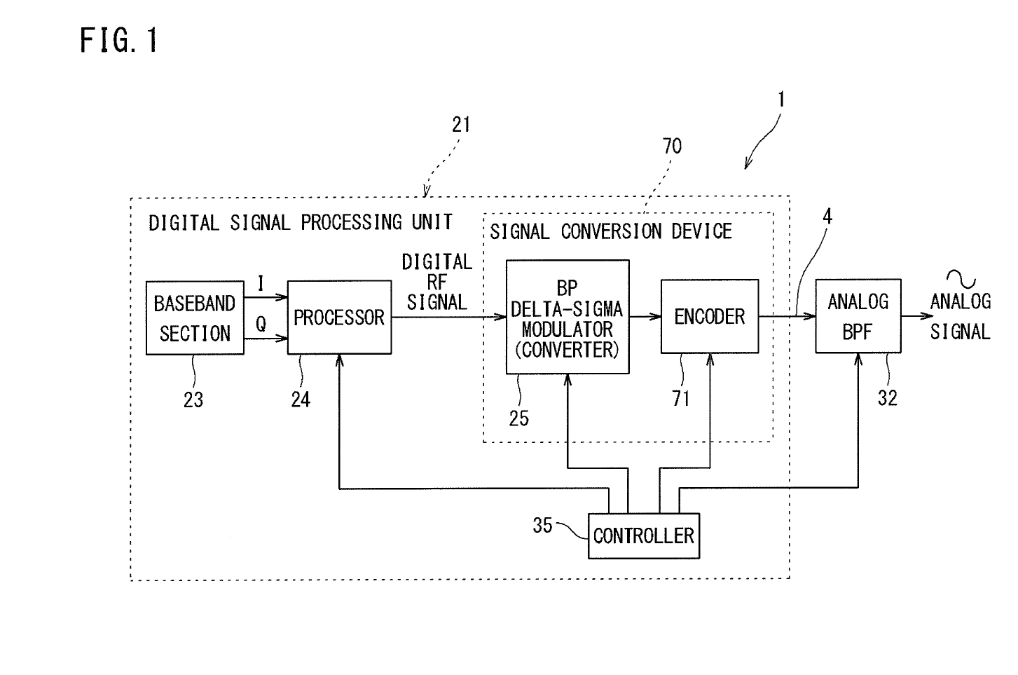

FIG. 1 shows a system 1 including a signal conversion device (signal conversion section) 70 according to an embodiment. The system 1 includes a digital signal processing unit 21 including the signal conversion device 70, and an analog filter 32.

The digital signal processing unit 21 outputs a digital signal (1-bit quantized signal; 1-bit pulse train) representing an RF (Radio Frequency) signal as an analog signal (modulated wave) based on the band transmission system. The RF signal is a signal to be emitted as a radio wave into space, and is, for example, an RF signal for mobile communication or an RF signal for broadcast services such as television/radio or the like.

The RF signal output from the digital signal processing unit 21 is provided to the analog filter (a band-pass filter or a low-pass filter) 32. The analog signal represented by the 1-bit pulse train also includes a noise component other than the RF signal. The noise component is removed by the analog filter.

The 1-bit pulse train is restored to a pure analog signal by simply being passed through the analog filter 32.

As described above, the digital signal processing unit 21 can substantially generate an RF signal by generating a 1-bit pulse train (1-bit quantized signal) in digital signal processing. Therefore, when the 1-bit pulse train representing the RF signal is provided to a circuit for processing an RF signal (e.g., an RF signal receiver such as a radio communication device or a television receiver), the circuit can process the 1-bit pulse train as an analog signal. In this case, the analog filter 32 may be included in the circuit for processing an RF signal.

Whether to use a band-pass filter or a low-pass filter as the analog filter 32 is appropriately determined based on the frequency of the RF signal.

A band-pass filter is used as the analog filter 32 when the signal conversion device 70 performs signal conversion based on band-pass delta-sigma modulation, whereas a low-pass filter is used as the analog filter 32 when the signal conversion device 70 performs signal conversion based on low-pass delta-sigma modulation.

A signal transmission line 4 provided between the digital signal processing unit 21 and the analog filter 32 may be a signal wiring formed on a circuit board, or a transmission line such as an optical fiber or an electric cable. The signal transmission line 4 need not be a dedicated line for transmitting a 1-bit pulse train, and may be a communication network that performs packet communication, such as the Internet. When a communication network that performs packet communication is used as the signal transmission line 4, the transmitter side (the digital signal processing unit 21 side) converts a 1-bit pulse train into a bit string and transmits the bit string to the signal transmission line 4, and the receiver side (analog filter 32 side) restores the received bit string to the original 1-bit pulse train.

The digital signal processing unit 21 can be regarded as a transmitter that transmits a 1-bit pulse train to the signal transmission line 4. In this case, a device including the analog filter 32 is a receiver of an RF signal.

Alternatively, the entire system 1 may be a transmitter 1. For example, the transmitter 1 may be configured to amplify, with an amplifier, a signal output from the digital signal processing unit 21, and output the signal from an antenna. In this case, the analog filter 32 may be provided between the digital signal processing unit 21 and the antenna, or the antenna may act as the analog filter 32.

The digital signal processing unit 21 includes a baseband section 23 that outputs a baseband signal (IQ signal) as a transmission signal, a processor 24 that performs processing such as digital quadrature modulation, a signal conversion device (signal conversion section) 70, and a controller 35.

The baseband section 23 outputs the IQ baseband signal (each of I signal and Q signal) as digital data.

The processor 24 subjects the IQ baseband signal to processing such as digital quadrature modulation. Accordingly, from the processor 24, a signal in a digital signal foil iat represented by multi-bit digital data (discrete values) is output.

The modulation performed by the processor 24 is not limited to the quadrature modulation, and may be another type of modulation for generating a modulated wave.

The processor 24 performs, in addition to quadrature modulation, various kinds of digital signal processing such as DPD (Digital Pre-distortion), CFR (Crest Factor Reduction), DUC (Digital Up Conversion), and the like. RF signals generated by the above-mentioned various kinds of digital signal processing are output from the processor 24.

A digital RF signal output from the processor 24 is provided to the signal conversion section 70. The signal conversion section 70 of the present embodiment is configured so as to have a band-pass delta-sigma modulator (converter 25), and an encoder 71. The converter 25 may be a low-pass delta-sigma modulator or a PWM modulator.

The delta-sigma modulator 25 performs delta-sigma modulation on the RF signal as an input signal, and outputs a 1-bit quantized signal (1-bit pulse train). The 1-bit pulse train output from the delta-sigma modulator 25 is a digital signal but represents an analog RF signal. The 1-bit pulse train output from the delta-sigma modulator 25 is provided to the encoder 71.

The encoder 71 has a frequency conversion function for an analog signal as described later. The encoder 71 performs frequency conversion of the RF signal by coding. Accordingly, the 1-bit quantized signal (1-bit pulse train) output from the encoder 71 represents the frequency-converted analog RF signal.

The 1-bit pulse train output from the encoder 71 is output from the digital signal processing unit 21 to a signal transmission line 4, as an output signal from the digital signal processing unit 21.

The controller 35 has a control function such as frequency control, and controls the respective components in the digital signal processing unit 21, and the analog filter 32.

[2. Delta-Sigma Modulation]

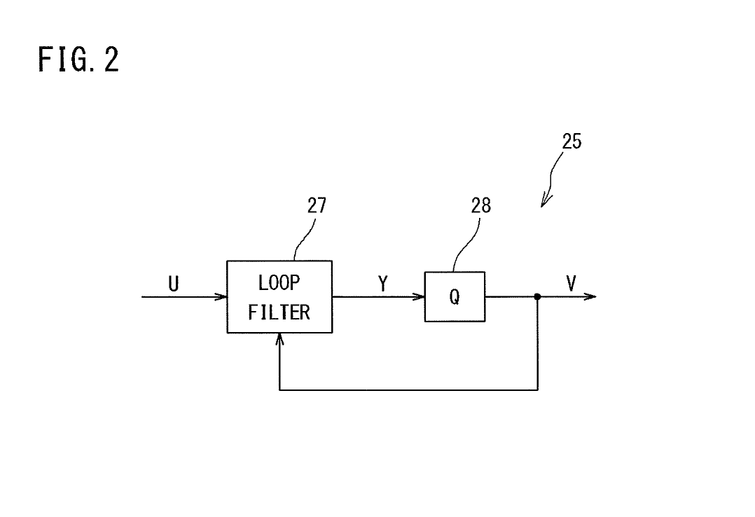

As shown in FIG. 2, the delta-sigma modulator 25 includes a loop filter 27 and a quantizer 28 (refer to Non-Patent Literature 1).

In the delta-sigma modulator 25 shown in FIG. 2, an input (an RF signal in the present embodiment) U is provided to the loop filter 27. An output Y from the loop filter 27 is provided to the quantizer (1-bit quantizer) 28. An output (quantized signal) V from the quantizer 28 is provided to the loop filter 27 as another input.

The characteristic of the delta-sigma modulator 25 can be expressed by a signal transfer function (STF) and a noise transfer function (NTF).

That is, when an input to the delta-sigma modulator 25 is defined as U, an output from the delta-sigma modulator 25 is defined as V, and quantization noise is defined as E, the characteristic of the delta-sigma modulator 25 expressed in the z domain is as follows:

[Math. 1]

V(z)=STF(z)U(z)+NTF(z)E(z) (1)

Therefore, when desired NTF and STF are given, the transfer function of the loop filter 27 can be obtained.

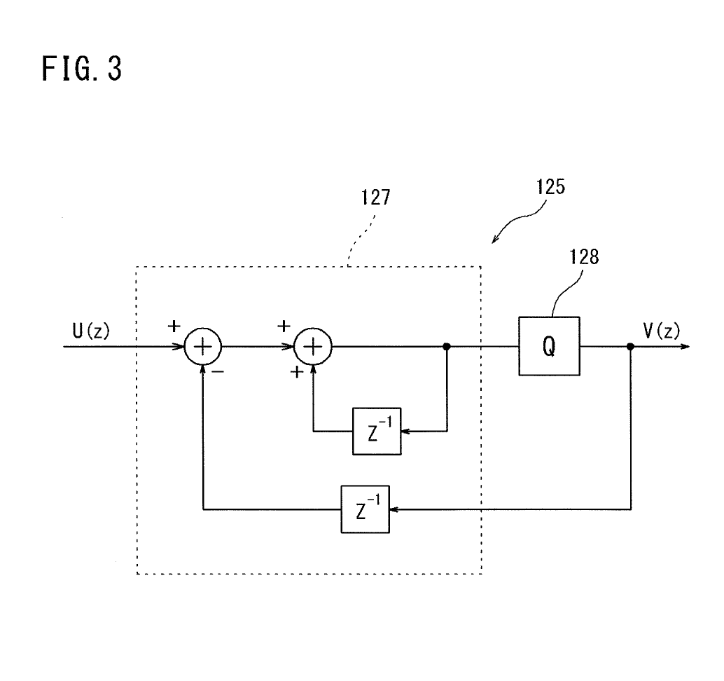

FIG. 3 is a block diagram showing a linear z domain model of a first-order low-pass delta-sigma modulator 125. Reference numeral 127 denotes a part corresponding to a loop filter, and reference numeral 128 denotes a quantizer. When an input to the delta-sigma modulator 125 is defined as U(z), an output therefrom is defined as V(z), and quantization noise is defined as E(z), the characteristic of the delta-sigma modulator 125 expressed in the z domain is as follows:

V(z)=U(z)+(1−z⁻¹)E(z)

That is, in the first-order low-pass delta-sigma modulator 125 shown in FIG. 3, the signal transfer function STF(z)=1, and the noise transfer function NTF(z)=1−z⁻¹.

According to Non-Patent Literature 1, by performing the following conversion on a low-pass delta-sigma modulator, the low-pass delta-sigma modulator can be converted into a band-pass delta-sigma modulator.

[Math. 2]

z→−z² (2)

According to the above conversion formula, by replacing z in the z domain model of the low-pass delta-sigma modulator 125 with z′=−z², a band-pass delta-sigma modulator is obtained.

By using the above conversion formula, an n-th order low-pass delta-sigma modulator (n is an integer not smaller than 1) can be converted into a 2n-th order band-pass delta-sigma modulator.

The present inventor has discovered a conversion formula for obtaining, from a low-pass delta-sigma modulator, a band-pass delta-sigma modulator having a desired frequency f₀ (θ=θ₀) as the center frequency f₀. This conversion formula is, for example, formula (3) below:

$$\begin{matrix}[ Math . 3 ] & \\ z \to z \frac{z - cos {θ}_{0}}{( cos {θ}_{0} ) z - 1} & ( 3 )\end{matrix}$$

where

θ₀=2π×(f₀/fs), and

fs is a sampling frequency of the delta-sigma modulator.

The conversion formula (2) relates to a specific frequency θ₀=π/2. In contrast, the conversion formula (3) has been generalized for any desired frequency (θ₀).

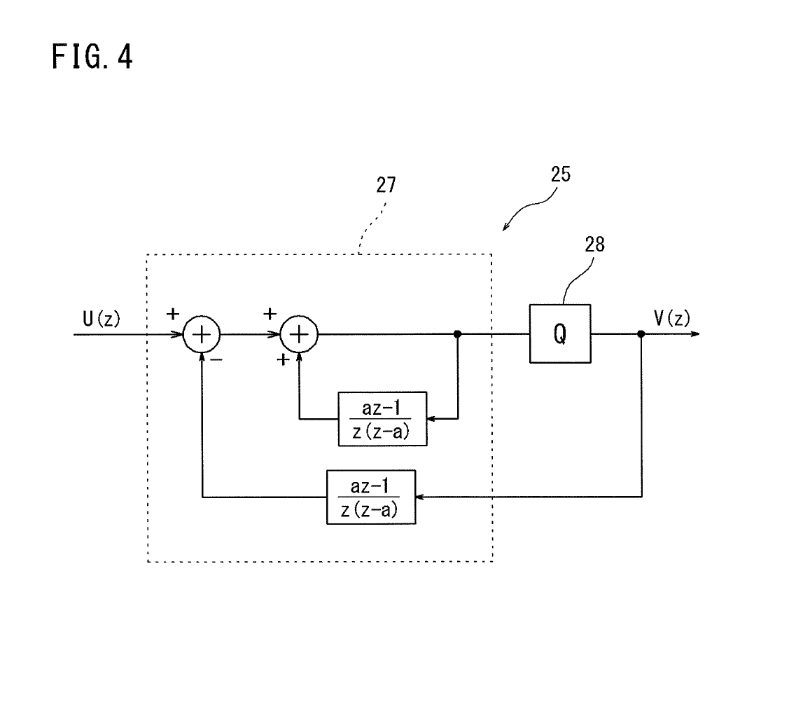

FIG. 4 shows a second-order band-pass delta-sigma modulator 25 obtained through conversion of the first-order low-pass delta-sigma modulator 125 shown in FIG. 3 based on the conversion formula (3).

In the conversion from FIG. 3 to FIG. 4, the following conversion formula which is formula (3) where cos θ₀ is replaced with a is used for convenience in expression.

$$z \to z \frac{z - a}{az - 1} \qquad [ Math . 4 ]$$

The conversion to the band-pass delta-sigma modulator is also applicable to other higher-order low-pass delta-sigma modulators (e.g., CIFB structure, CRFF structure, CIFF structure, and the like described in Non-Patent Literature 1).

The delta-sigma modulator 25 can convert the value of z based on the above formula (3). That is, the delta-sigma modulator 25 can change the center frequency of the quantization noise stop band. In other words, the quantization noise stop band can be changed.

The controller 35 converts the value of z of the delta-sigma modulator 25 based on the above formula (3) in accordance with the center frequency (the carrier frequency f₀ described above) of the signal input to the delta-sigma modulator 25, thereby allowing band-pass delta-sigma modulation to be performed on the signal of the desired frequency.

As described above, by changing cos θ₀ (coefficient a) in the above conversion formula (3) according to the carrier frequency f₀ of the RF signal, band-pass delta-sigma modulation corresponding to the desired frequency f₀ can be performed without changing the sampling frequency fs. If cos θ₀ is changed, the coefficient of the NTF shown in formula (1) is changed, but the order of the formula is maintained. Thus, even if the configuration of the band-pass delta-sigma modulator 25 is changed in accordance with the carrier frequency f₀ of the RF signal, the complexity (order) of the formula is not changed, and therefore, signal processing load in the band-pass delta-sigma modulator 25 is not changed either.

As described above, in the present embodiment, advantageously, even if the carrier frequency f₀ is changed, signal processing load in the band-pass delta-sigma modulator 25 is not changed. In the present embodiment, the signal processing load in the band-pass delta-sigma modulator 25 depends on the sampling frequency fs determined based on the signal bandwidth, in accordance with the Nyquist's theorem. However, even if the carrier frequency f₀ is changed, the signal bandwidth is not changed, and thus, the sampling frequency fs need not be changed. When the delta-sigma modulator is a low-pass type, in order to cope with a change of the carrier frequency f₀, the sampling frequency fs needs to be changed. In this point, a band-pass type is advantageous.

Further, use of formula (3) allows the delta-sigma modulator 25 to be used not only as a band-pass delta-sigma modulator corresponding to the desired frequency (f₀) but also as a low-pass delta-sigma modulator. That is, the delta-sigma modulator 25 can be switched between the low-pass type and the band-pass type.

Further, the controller 35 controls the processor 24 to change the frequency of the RF signal to be output from the processor 24 to any desired frequency, and provide the RF signal to the delta-sigma modulator 25.

Since frequency conversion (frequency shift) of the RF signal is performed by the encoder 71 as described later, the frequency of the RF signal to be output from the processor 24 may be changed such that an amount of frequency shift by the encoder 71 is considered in the frequency of the RF signal desired to be output from the encoder 71.

The controller 35 determines the frequency of the RF signal desired to be output from the encoder 71, and performs, according to the determined frequency, control so as to change the frequency of the RF signal to be output from the processor 24.

In addition, the controller 35 controls the encoder 71 to conform to the frequency of the RF signal desired to be output from the encoder 71, and controls the center frequency and the passband of the analog filter 32.

[3. Relationship Between Signal Characteristic and 1-Bit Pulse Train Waveform]

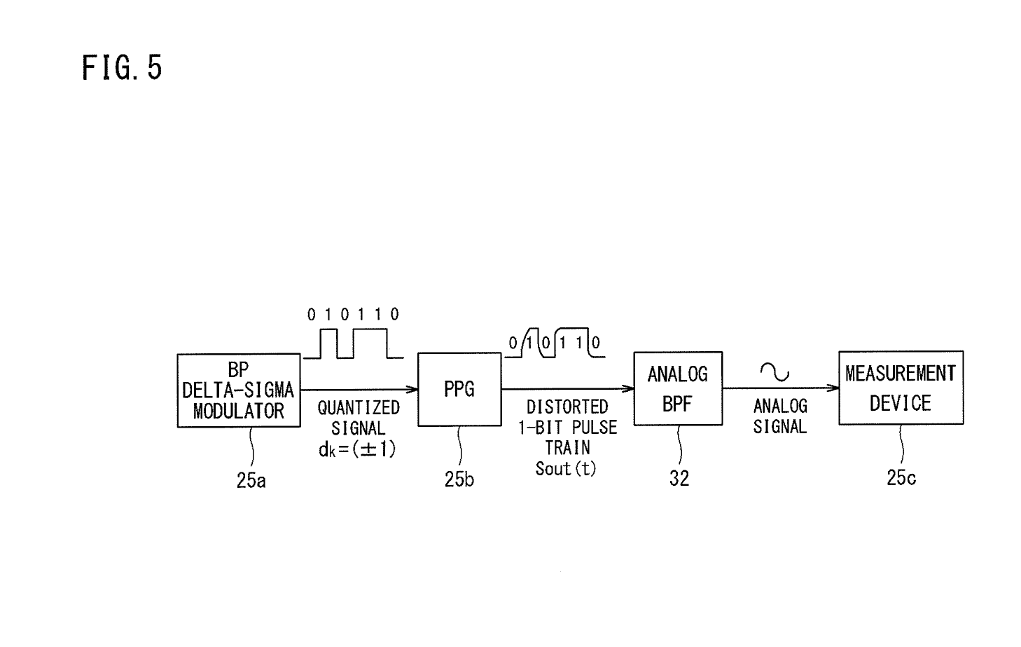

FIG. 5 shows a device configuration used for examining the relationship between the signal characteristic of the RF signal represented by the 1-bit pulse train output from the delta-sigma modulator (converter) 25, and the analog waveform of the 1-bit pulse train.

Since the actual band-pass delta-sigma modulator 25 shown in FIG. 1 outputs a quantized signal as a pulse, the modulator 25 includes, in at least a part thereof, hardware such as a flip-flop.

However, as the delta-sigma modulator shown in FIG. 5, a band-pass delta-sigma modulator 25a configured by software was used. A quantized signal dₖ output from the band-pass delta-sigma modulator 25a configured by software is provided to a pulse pattern generator (PPG) 25b. The pulse pattern generator 25b, based on the quantized signal dₖ, can output a 1-bit pulse train Sₒᵤₜ(t) that is distorted in any shape with respect to an ideal waveform (perfect square wave). The distorted 1-bit pulse train Sₒᵤₜ(t) corresponds to a 1-bit pulse train output from the actual band-pass delta-sigma modulator 25.

An output circuit of the pulse pattern generator 25b has fast response performance sufficient to generate a waveform that can be regarded as the ideal waveform. Accordingly, the pulse pattern generator 25b is also able to output a 1-bit pulse train Sₒᵤₜ(t) having the ideal waveform.

The signal output from the pulse pattern generator 25b passes through the analog band-pass filter 32, and is provided to a measurement device 25c.

The output Sₒᵤₜ(t) of the pulse pattern generator 25b is defined as shown in the following formula (A):

[Math. 5]

Sₒᵤₜ(t)=S_{ideal}(t)+Σₖf(t−kT){U(t−kT)−U(t−T−kT)} (A)

S_{Ideal}(t), the first term of formula (A), expresses the ideal square waveform of the quantized signal dₖ (=±1), and is defined as shown in the following formula (B). The quantized signal dₖ takes+1 as a value corresponding to a high level of the pulse, and takes −1 as a value corresponding to a low level of the pulse. U(t) is a unit step function.

[Math. 6]

S_{Ideal}(t)=Σₖdₖ{U(t−kT)−U(t−T−kT)} (B)

The second term of formula (A) indicates a difference between Sₒᵤₜ(t) corresponding to the actual waveform and the ideal waveform S_{Ideal}(t). In addition, f(t−kt) in the second term is defined as shown in the following formula (C). Sing is a sign function.

$$\begin{matrix}[ Math . 7 ] & \\ f ( t - kT ) = \{ \begin{matrix}{f}_{rise} ( t - kT ) … Sing ( {d}_{k} - {d}_{k - 1} ) = 1 ( C \text{-} 1 ) \\ {f}_{fall} ( t - kT ) … Sing ( {d}_{k} - {d}_{k - 1} ) = - 1 ( C \text{-} 2 ) \\ 0 … Sing ( {d}_{k} - {d}_{k - 1} ) = 0 ( C \text{-} 3 )\end{matrix} & ( C ) \\ [ Math . 8 ] & \\ \{ \begin{matrix}{f}_{rise} ( t ) = {f}_{Asym} ( t ) + {f}_{Sym} ( t ) ( D \text{-} 1 ) \\ {f}_{fall} ( t ) = {f}_{Asym} ( t ) - {f}_{Sym} ( t ) ( D \text{-} 2 )\end{matrix} & ( D )\end{matrix}$$

In formula (C), (C-1) represents a case where the sign of a value indicating a difference between a value dₖ of a certain quantized signal and a value dₖ₋₁ of a quantized signal which is temporally one signal before the certain quantized signal is plus, that is, a case where the quantized signal dₖ is at a rising edge of the pulse.

(C-2) represents a case where the sign of the value indicating the difference between the value dₖ of the certain quantized signal and the value dₖ₋₁ of the quantized signal which is temporally one signal before the certain quantized signal is minus, that is, a case where the quantized signal dₖ is at a falling edge of the pulse.

(C-3) represents a case where the value indicating the difference between the value dₖ of the certain quantized signal and the value dₖ₋₁ of the quantized signal which is temporally one signal before the certain quantized signal is zero, that is, a case where the value of the pulse does not change.

In addition, fᵣᵢₛₑ(t) and f_{fall}(t) indicate a rising waveform and a falling waveform, respectively. The rising waveform fᵣᵢₛₑ(t) and the falling waveform f_{fall}(t) are set to any shapes for simulation.

Further, each of fᵣᵢₛₑ(t) and f_{fall}(t) can be decomposed to a symmetric component f_{sym}(t) and an asymmetric component f_{Asym}(t) as shown in formula (D).

The asymmetric component f_{Asym}(t) can be obtained from formula (D) according to the following formula (E):

$$\begin{matrix}[ Math . 9 ] & \\ {f}_{Asym} ( t ) = \frac{{f}_{rise} ( t ) + {f}_{fall} ( t )}{2} & ( E )\end{matrix}$$

Formula (E) indicates that the asymmetric component f_{Asym}(t) is eliminated when the rising waveform fᵣᵢₛₑ(t) and the falling waveform f_{fall}(t) satisfy the relationship expressed by the following formula (F):

[Math. 10]

fᵣᵢₛₑ(t)=−f_{fall}(t) (F)

When formula (F) is satisfied, the rising waveform fᵣᵢₛₑ(t) and the falling waveform f_{fall}(t) are line-symmetric with respect to the time axis. That is, when a pulse waveform satisfying formula (F) is shown as an eye pattern, the eye pattern is line-symmetric with respect to the time axis.

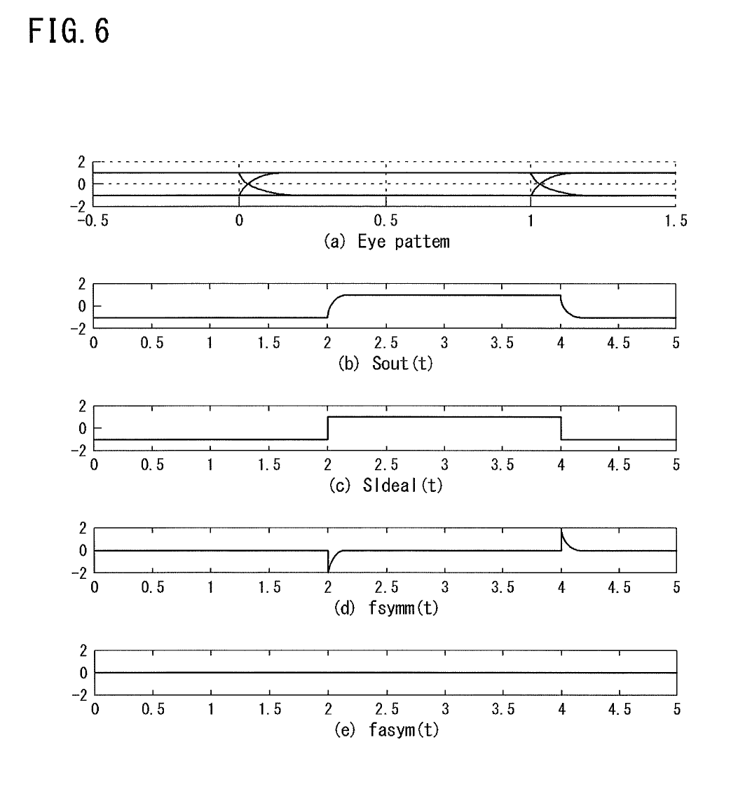

FIG. 6 shows a pulse waveform (symmetric waveform) that satisfies formula (F). FIG. 6(a) shows an eye pattern of a symmetric waveform Sₒᵤₜ(t). This eye pattern is line-symmetric with respect to the time axis. It is assumed that the time axis is in the middle (0) between the low level (−1) and the high level (+1) of the pulse (the same applies hereinafter).

FIG. 6(b) shows a time axis waveform of the symmetric waveform Sₒᵤₜ(t), FIG. 6(c) shows an ideal waveform S_{ideal}(t) with respect to the symmetric waveform, FIG. 6(d) shows a symmetric component f_{sym}(t) in the rising waveform fᵣᵢₛₑ(t) and the falling waveform f_{fall}(t) in the symmetric waveform, and FIG. 6(e) shows an asymmetric component f_{Asym}(t) in the rising waveform fᵣᵢₛₑ(t) and the falling waveform f_{fall}(t) in the symmetric waveform.

As shown in FIG. 6, the symmetric waveform is distorted with respect to the ideal waveform S_{ideal}(t), and has distortion components. Specifically, the rising waveform fᵣᵢₛₑ(t) of the pulse has a distortion component (first distortion component), and the falling waveform f_{fall}(t) of the pulse has a distortion component (second distortion component).

When formula (F) is satisfied, the distortion components include the symmetric component f_{sym}(t) (refer to FIG. 6(d)) but do not include the asymmetric component f_{Asym}(t) (refer to FIG. 6(e)).

In the symmetric waveform, when the rising waveform fᵣᵢₛₑ(t) and the falling waveform f_{fall}(t) are overlapped such that a rising start point and a falling start point coincide with each other on the time axis, like an eye pattern, the rising waveform fᵣᵢₛₑ(t) and the falling waveform f_{fall}(t) are line-symmetric with respect to the time axis because the transition time (rising time) of the rising waveform fᵣᵢₛₑ(t) is equal to the transition time (falling time) of the falling waveform f_{fall}(t).

In other words, the distortion component (first distortion component) in the rising waveform fᵣᵢₛₑ(t) and the distortion component (second distortion component) in the falling waveform f_{fall} (t) are line-symmetric with respect to the time axis, and the asymmetric component f_{Asym}(t) is zero.

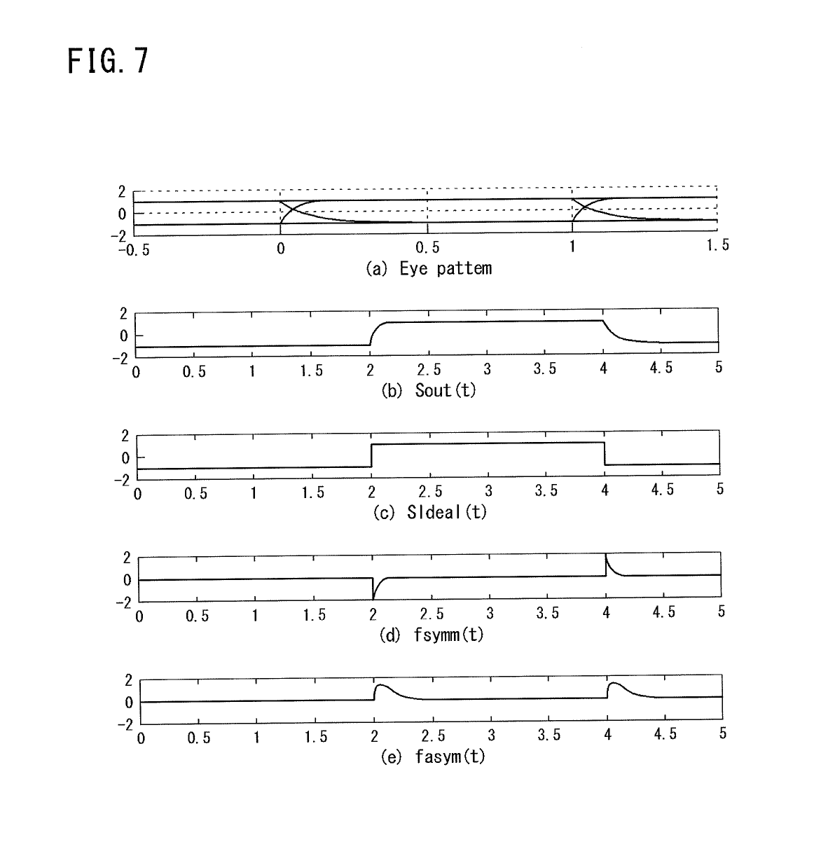

FIG. 7 shows a pulse waveform (asymmetric waveform) that does not satisfy formula (F). FIG. 7(a) shows an eye pattern of an asymmetric waveform Sₒᵤₜ(t). This eye pattern is asymmetric with respect to the time axis. Specifically, in the asymmetric waveform shown in FIG. 7, the pulse falling time is longer than the pulse rising time.

FIG. 7(b) shows a time axis waveform of the asymmetric waveform Sₒᵤₜ(t), FIG. 7(c) shows an ideal waveform S_{ideal}(t) with respect to the asymmetric waveform, FIG. 7(d) shows a symmetric component f_{sym}(t) in the rising waveform fᵣᵢₛₑ(t) and the falling waveform f_{fall}(t) in the asymmetric waveform, and FIG. 7(e) shows an asymmetric component f_{Asym}(t) in the rising waveform fᵣᵢₛₑ(t) and the falling waveform f_{fall}(t) in the asymmetric waveform.

As shown in FIG. 7, the asymmetric waveform is also distorted with respect to the ideal waveform S_{ideal}(t), and has distortion components. Specifically, the rising waveform fᵣᵢₛₑ(t) of the pulse has a distortion component (first distortion component), and the falling waveform f_{fall}(t) of the pulse has a distortion component (second distortion component).

When formula (F) is not satisfied, the distortion components include the asymmetric component f_{Asym}(t) as well as the symmetric component f_{sym}(t) (refer to FIG. 7(d) and FIG. 7(e)).

[3.2 Influence of Asymmetric Component f_{Asym}(t) on Signal Characteristic]

A simulation was performed in order to examine influences of pulse waveforms on signal characteristic (ACLR) of an analog signal. The result of the simulation is described hereinafter.

In the simulation, a sixth-order CRFB band-pass delta-sigma modulator was adopted as the delta-sigma modulator 25. A test signal to be input to the band-pass delta-sigma modulator 25 is an RF signal based on LTE (Long Term Evolution). The carrier frequency is 800 MHz, the bandwidth is 5 MHz, and four carriers are used. That is, the total bandwidth of the RF signal is 20 MHz.

TABLE 1

| | | | | Result ACLR[dB] | | | |
|---|---|---|---|---|---|---|---|
| | Parameter Transition time [UI] | | | | | Sout Removal of | |
| | Symm./ | Rising | Falling | Sout | | asymmetric waveform | |
| Waveform | Asymm. | time α | time β | ACLR1 | ACLR2 | ACLR1′ | ACLR2′ |
| Ideal | Symm. | 0 | 0 | 64.4 | 62.6 | | |
| exp(x) | | 0.2 | 0.2 | 64.4 | 62.6 | | |
| | | 0.4 | 0.4 | 64.4 | 62.6 | | |
| tanh(x) | | 0.2 | 0.2 | 64.4 | 62.6 | | |
| | | 0.4 | 0.4 | 64.4 | 62.6 | | |
| exp(x) | Asymm. | 0.2 | 0.4 | 43.1 | 42.6 | 64.4 | 62.6 |
| | | 0.4 | 0.2 | 43.2 | 42.6 | 64.4 | 62.6 |
| tanh(x) | | 0.2 | 0.4 | 34.9 | 34.9 | 64.4 | 62.6 |
| | | 0.4 | 0.2 | 34.4 | 34.2 | 64.4 | 62.6 |

Pulse waveforms used in the simulation were as follows: an ideal waveform “Ideal” having transition times (rising time α and falling time β) of zero; a waveform “exp(x)” having a rising waveform and a falling waveform expressed by exponential functions; and a waveform “tan h(x)” having a rising waveform and a falling waveform expressed by hyperbolic tangent functions.

As for the exp(x) and the tan h(x), a symmetric waveform (Symm.) in which a rising waveform and a falling waveform are line-symmetric with respect to the time axis and an asymmetric waveform (Asymm.) in which a rising waveform and a falling waveform are line-asymmetric with respect to the time axis, were used.

As for the line-symmetric waveform, the rising time α and the falling time β were made equal to each other (α=β), and simulations were performed for two cases where α=β=0.2 and where α=β=0.4.

As for the line-asymmetric waveform, the rising time α and the falling time β were made different from each other (α≠β), and simulations were performed for two cases where α=0.2 and β=0.4, and where α=0.4 and β=0.2.

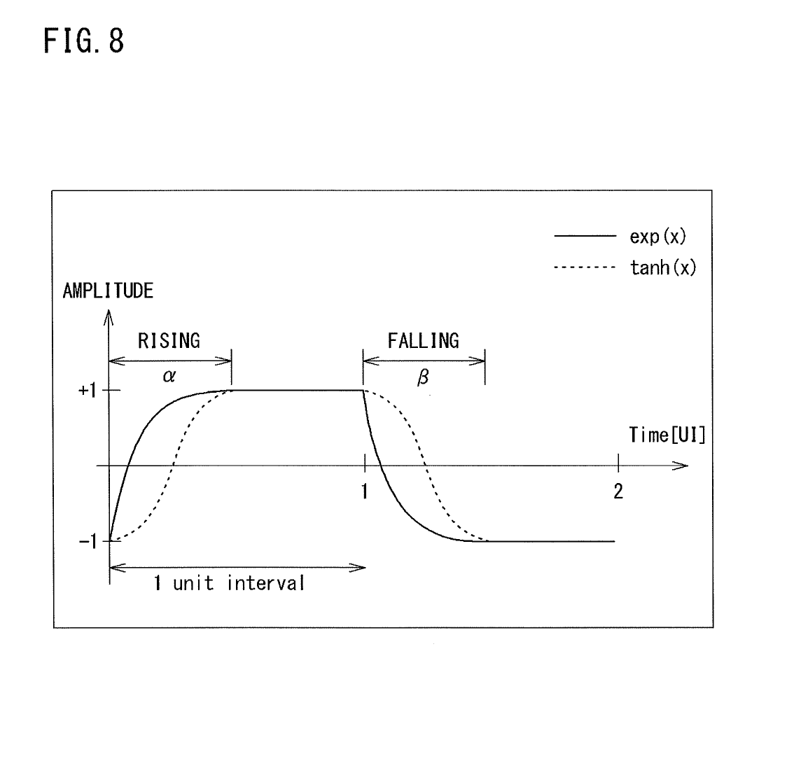

FIG. 8 shows definitions of simulation parameters (the waveforms and the transition times α and β). In FIG. 8, the rising waveform and the falling waveform of the exp(x) are shown by solid lines, and the rising waveform and the falling waveform of the tan h(x) are shown by dotted lines.

The transition times α and β are each expressed as a ratio to a unit interval (UI). The unit interval is an interval of one pulse corresponding to one quantized signal, and has a length of 1/fs.

The rising time is a time period during which a pulse at a low level (−1) reaches a high level (+1), and the falling time is a time period during which the pulse at the high level (+1) reaches the low level (−1).

With reference to the simulation results shown in Table 1, ACLR1 indicates an adjacent channel leakage power ratio, and ACLR2 indicates a next adjacent channel leakage power ratio. In addition, ACLR1′ and ACLR2′ indicate an adjacent channel leakage power ratio and a next adjacent channel leakage power ratio, respectively, in the case where the asymmetric component f_{Asym}(t) is eliminated from the asymmetric waveform (Asymm.).

According to the simulation results shown in Table 1, as for the symmetric waveform (Symm.), ACLR1 and ACRL2 similar to those of the ideal waveform were obtained for both the exp(x) and the tan h(x) which are not ideal waveforms. In addition, in the symmetric waveform (Symm.), the ACLR1 and the ACRL2 were not influenced by the difference between the transition times α and β.

Therefore, it is considered that the lengths of the transition times α and β are not important to the signal characteristic (ACLR1 and ACLR2). That is, even if the pulse waveform is distorted with respect to the ideal waveform, the ACLR1 and the ACRL2 are not reduced as long as the pulse waveform is a symmetric waveform. Therefore, it is considered that the distortion component itself included in the pulse waveform does not adversely affect the signal characteristic.

On the other hand, as for the asymmetric waveform (Asymm.), for both the exp(x) and the tan h(x), the ACLR1 and the ACLR2 were reduced as compared to those in the symmetric waveform (Symm.). However, when the asymmetric component f_{Asym}(t) was eliminated from each asymmetric waveform (Asymm.), the ACLR1′ and the ACLR2′ were equal to the ACLR1 and the ACLR2 of the symmetric waveform (Symm.).

Thus, it is found that degradation of the ACLR1 and the ACLR2 is caused by the asymmetric component f_{Asym}(t).

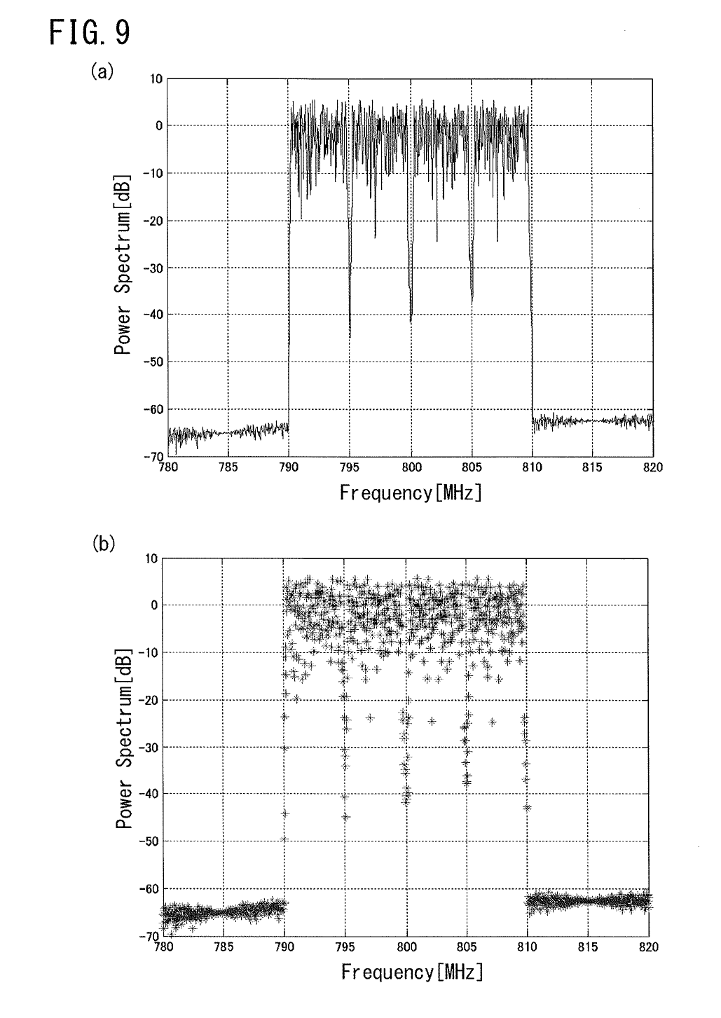

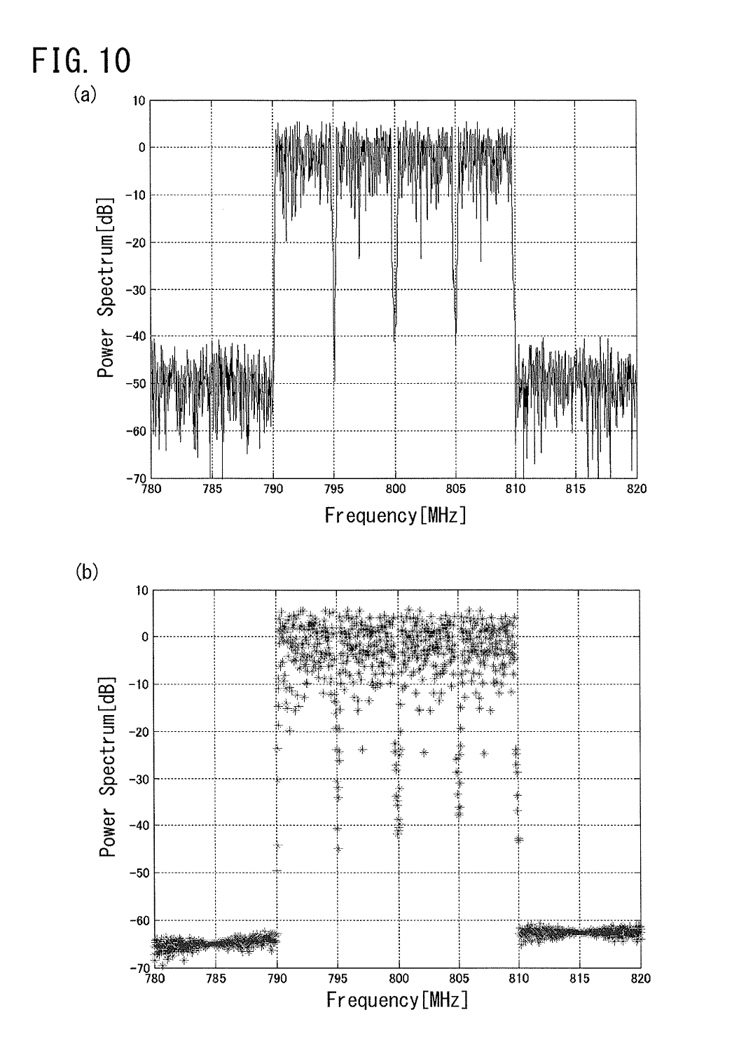

FIG. 9 shows a power spectrum in the case where the pulse waveform “exp(x)” is a symmetric waveform (Symm.), and FIG. 10 shows a power spectrum in the case where the pulse waveform “exp(x)” is an asymmetric waveform (Asymm.).

FIG. 9(a) shows a power spectrum of a 1-bit pulse train Sₒᵤₜ(t) in the case where α=β=0.2, and FIG. 9(b) shows a power spectrum of a 1-bit pulse train Sₒᵤₜ(t) in the case where α=β=0 (ideal waveform). According to FIG. 9, the power spectrum in the case where α=β=0.2 and the power spectrum in the case where α=β=0 (ideal waveform) are almost the same. That is, even in the case where α=β=0.2, degradation from the case where α=β=0 (ideal waveform) is not recognized.

FIG. 10(a) shows a power spectrum of the pulse waveform “exp(x)” in the case where α=0.2 and β=0.3, and FIG. 10(b) shows a power spectrum in the case where the asymmetric component is eliminated from the pulse waveform “exp(x)” in the case where α=0.2 and β=0.3.

Before the elimination of the asymmetric component (the power spectrum shown in FIG. 10(a)), leakage power is recognized outside the frequency band of the RF signal (790 MHz to 810 MHz). On the other hand, after the elimination of the asymmetric component (the power spectrum shown in FIG. 10(b)), the leakage power outside the frequency band of the RF signal is reduced, resulting in a power spectrum similar to that shown in FIG. 9(b).

Also for the tan h(x), measurement results similar to those shown in FIG. 9 and FIG. 10 are obtained.

Further, similar results were obtained for waveforms other than the exp(x) and the tan h(x).

According to the simulation results, when a pulse has an ideal waveform which is a complete square wave, satisfactory values of ACLR1 and ACLR2 are obtained. However, an attempt to generate more complete square wave causes an increase in the device cost. In addition, such a square wave is not desirable because of many harmonic components contained therein, and causes an increase in power consumption.

Accordingly, the actual signal conversion section 70 (delta-sigma modulator 25) is preferably configured to output, not an ideal waveform which is a complete rectangle wave, but a pulse waveform including distortion components.

Regarding this point, according to the simulation results, even if a pulse waveform includes distortion components, the distortion components do not cause degradation of signal characteristic as long as the pulse waveform is line-symmetric with respect to the time axis, that is, as long as the pulse waveform does not include an asymmetric component.

Here, “the distortion components are substantially line-symmetric with respect to the time axis” means “the distortion components need not be completely line-symmetric with respect to the time axis”. For example, the distortion components may have line symmetry such that the ACLR (adjacent channel leakage power ratio) is 45 [dB] or more. Preferably, the distortion components may have line symmetry such that the ACLR is 46 [dB] or more, more preferably, 48 [dB] or more, still more preferably, 50 [dB] or more, yet more preferably, 55 [dB] or more, and further preferably, 60 [dB] or more.

Further, the symmetry of the distortion components need not be considered regarding each pulse corresponding to the unit interval (UI), and may be considered regarding an average of distortion components in many unit intervals (UI).

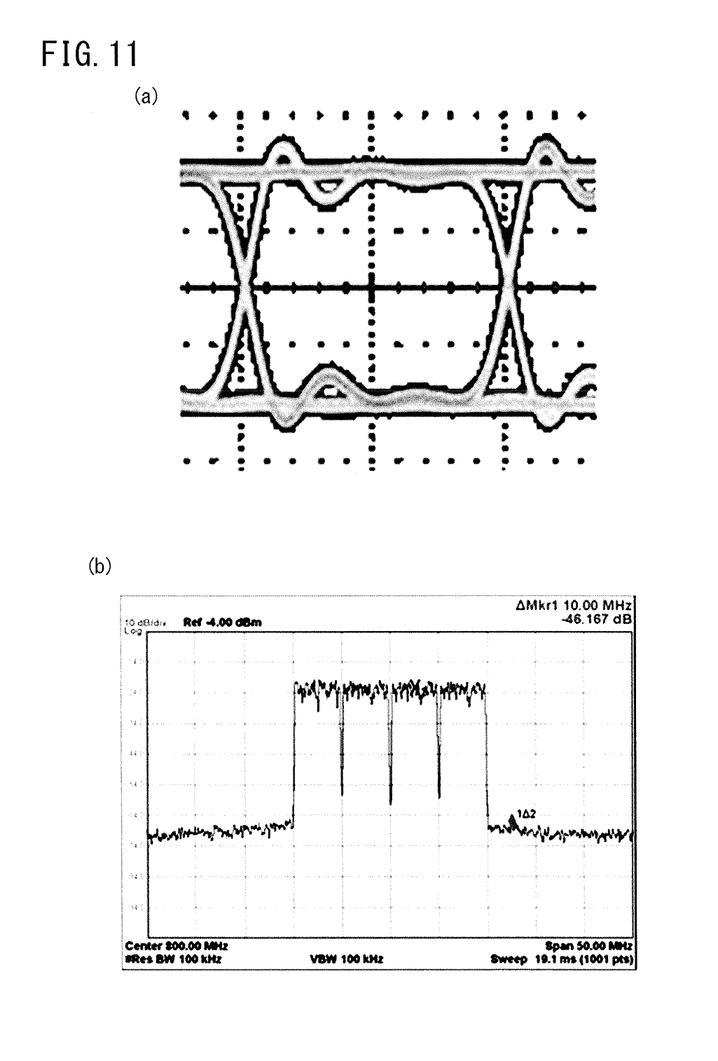

FIG. 11 shows a result of measurement of a 1-bit pulse train output from the delta-sigma modulator 25 shown in FIG. 1. FIG. 11(a) shows a measured eye pattern, and FIG. 11(b) shows a measured power spectrum. The measured pulse waveform (the eye pattern shown in FIG. 11(a)) includes an asymmetric component, and the ACLR is 46.1 [dB].

The trajectory of the eye pattern shown in FIG. 11(a) was digitized, and a rising waveform fᵣᵢₛₑ(t) and a falling waveform f_{fall}(t) were extracted. Based on the extracted rising waveform fᵣᵢₛₑ(t) and falling waveform f_{fall}(t), an asymmetric component f_{Asym}(t) was calculated by using formula (E).

The calculated asymmetric component f_{Asym}(t) was eliminated from the measured pulse waveform, and the ACLR was calculated again. Then, the ACLR was improved to 52.3 [dB].

[4. Encoder]

The encoder 71 shown in FIG. 1 acts as a suppressing section for suppressing distortion components in the 1-bit pulse train output from the delta-sigma modulator 25, and asymmetry of the distortion components.

The encoder 71 executes a coding process (baseband line coding) on the 1-bit pulse train output from the delta-sigma modulator 25. The encoder 71 prevents fluctuation of the transition time which is caused by that High (1) continuously occurs in the 1-bit pulse train output from the delta-sigma modulator 25.

In a circuit (e.g., a flip-flop) included in the delta-sigma modulator 25 for the purpose of pulse output, a switching element (e.g., a MOS-FET) for outputting High is constantly in its on state while High (1) continues, and the temperature increases due to current that flows through the switching element. Even if the switching element is turned off in such a state, transition from High (1) to Low (−1 or 0) takes time, and thereby the falling delay time β increases. As a result, the falling time β becomes longer than the rising time α, resulting in an asymmetric component.

Therefore, the encoder 71 shown in FIG. 1 performs coding by using a line code that prevents High (1) from continuing in the 1-bit pulse train.

The encoder 71 of the present embodiment performs a coding process by using an RZ (Return Zero) code. The present inventor has experimentally discovered that, among various baseband line coding schemes, RZ coding and Manchester coding enable preservation of the spectrum of an analog signal represented by a 1-bit pulse train, merely with the frequency of the analog signal represented by the 1-bit pulse train being converted.

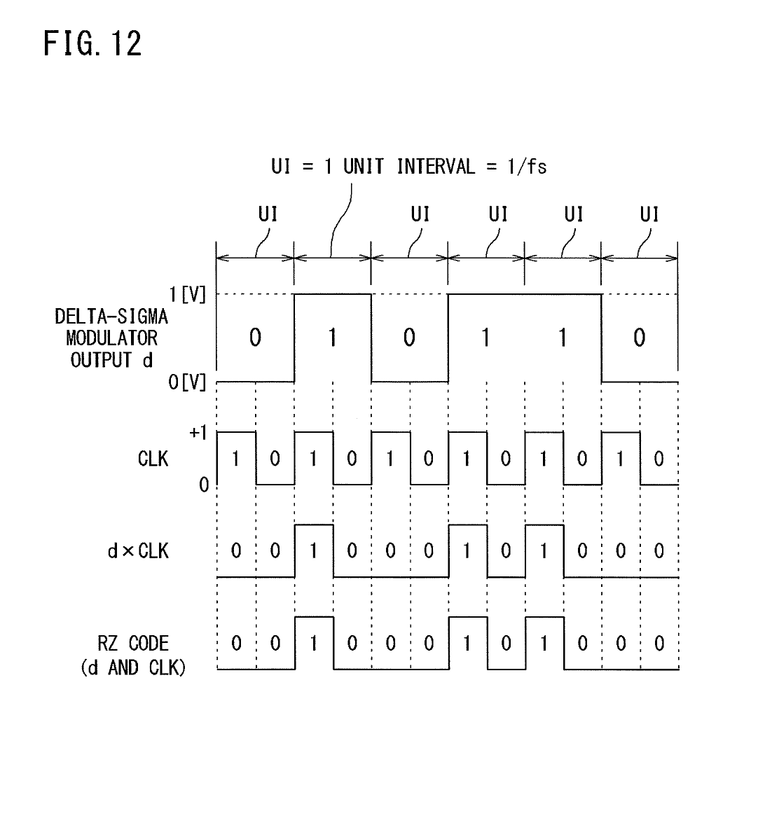

In the coding using the RZ code, as shown in FIG. 12, 0 (Low) is converted into “00” and 1 (High) is converted into “10”. By the coding using the RZ code, even when 1 (High) continues in the output (1-bit pulse train) of the delta-sigma modulator 25, the consecutive 1s (High) are converted into alternate 1s (High) and 0s (Low) in the RZ code.

Therefore, even when 1 (High) continues in the output (1-bit pulse train) of the delta-sigma modulator 25, occurrence of consecutive 1s (High) is suppressed in the output (1-bit pulse train) of the encoder 71.

As a result, in the delta-sigma modulator 25, even when the distortion components are made asymmetric due to the internal factor of the delta-sigma modulator 25, i.e., heat generated in the flip-flop due to the consecutive 1s (High), since the consecutive 1s (High) are reduced in the 1-bit pulse train output from the encoder 71, the asymmetry of the distortion components is also suppressed.

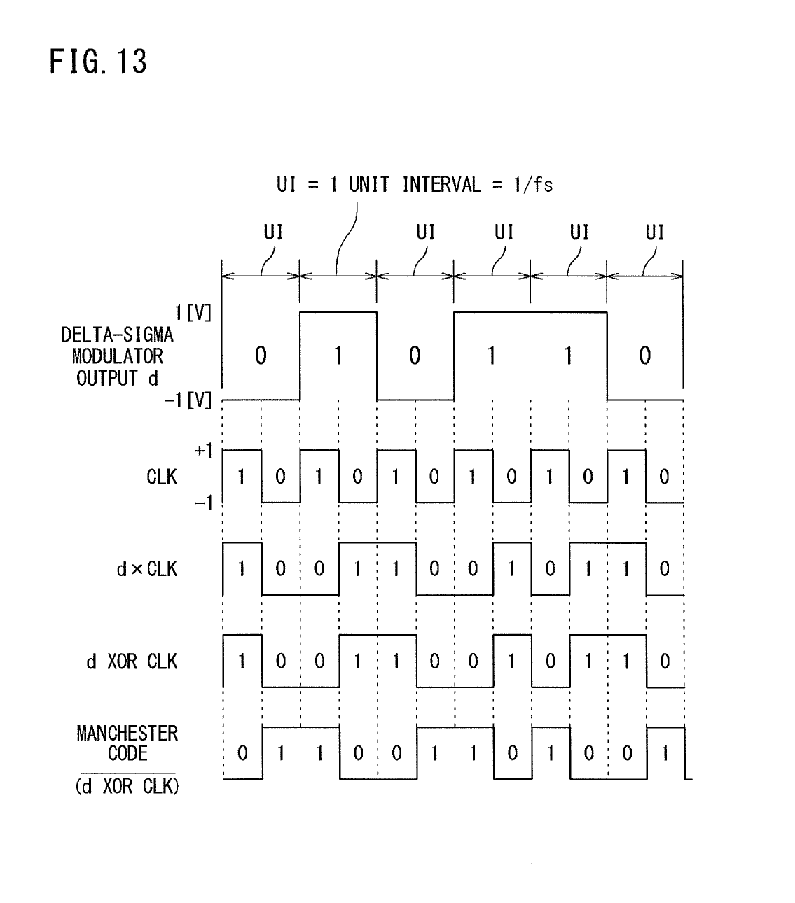

In the coding using a Manchester code, as shown in FIG. 13, 0 (Low) is converted into “01” and 1 (High) is converted into “10”. By the coding using the Manchester code, even when 1 (High) continues in the output (1-bit pulse train) of the delta-sigma modulator 25, the consecutive 1s (High) are converted into alternate 1s (High) and 0s (Low) in the Manchester code.

Therefore, even when 1 (High) continues in the output (1-bit pulse train) of the delta-sigma modulator 25, occurrence of consecutive is (High) is suppressed in the output (1-bit pulse train) of the encoder 71.

As a result, in the delta-sigma modulator 25, even when the distortion components are made asymmetric due to the internal factor of the delta-sigma modulator 25, i.e., heat generated in the flip-flop due to the consecutive 1s (High), since the consecutive 1s (High) are reduced in the 1-bit pulse train output from the encoder 71, the asymmetry of the distortion components is also suppressed.

As shown in FIG. 12, when High (1) and Low (0) of the pulse are represented by +1 [V] and 0 [V], respectively, a result obtained by executing an RZ coding process on an output d from the delta-sigma modulator 25 (a logical product (d AND CLK) between the delta-sigma modulator output d and a clock CLK) coincides with an arithmetic product (d×CLK) between the output d from the delta-sigma modulator 25 and the clock CLK.

Further, as shown in FIG. 13, when High (1) and Low (0) of the pulse are represented by +1 [V] and −1 [V], respectively, a result obtained by executing a Manchester coding process on the output d from the delta-sigma modulator 25 coincides with the arithmetic product (d×CLK) between the delta-sigma modulator output d and the clock CLK, except that 0 and 1 are inverted. The Manchester coding process corresponds to inversion of an exclusive OR (d XOR CLK) between the delta-sigma modulator output d and the clock CLK.

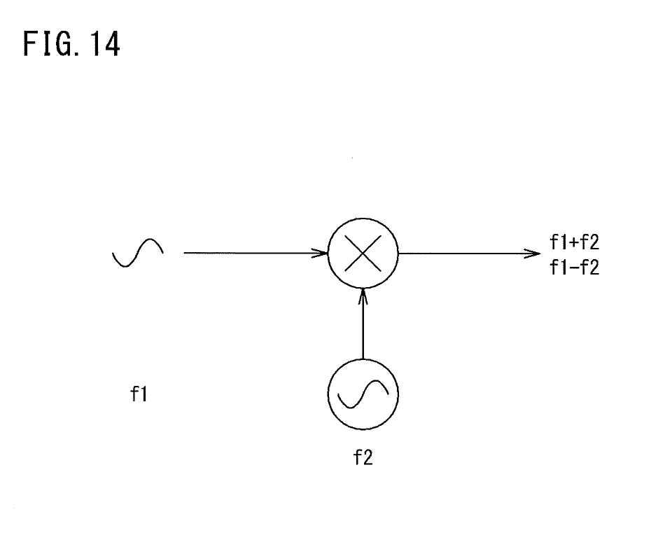

As shown in FIG. 14, in an analog signal, an arithmetic product between a signal of a frequency f1 (d) and a frequency f2 (CLK) corresponds to frequency conversion into a frequency f1+f2 and a frequency f1−f2.

Accordingly, the RZ coding and the Manchester coding performed on the pulse output from the delta-sigma modulator 25 corresponds to frequency conversion in terms of an analog signal.

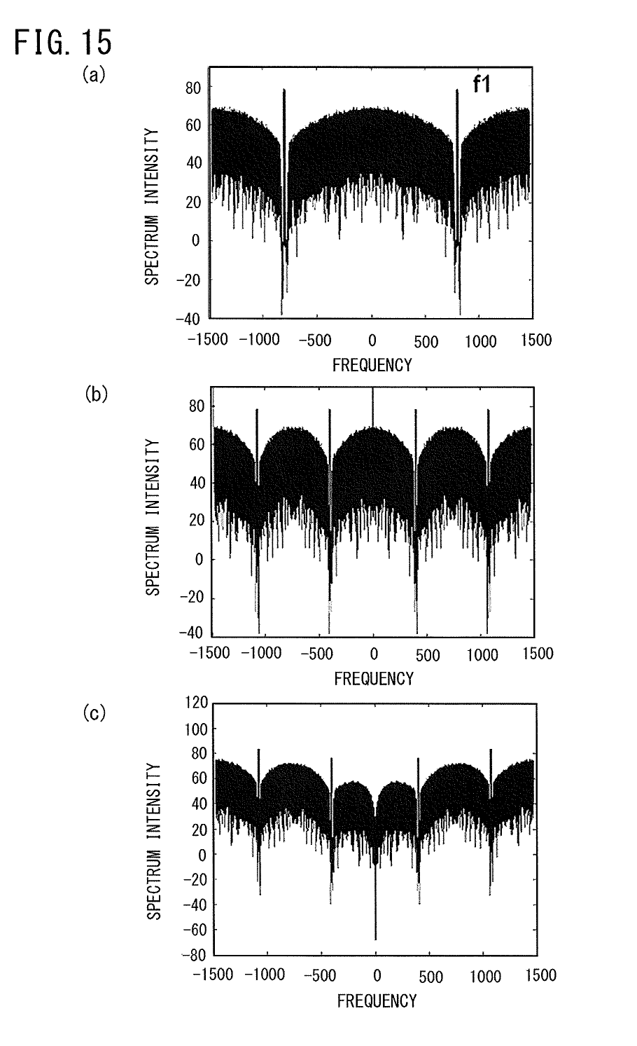

FIG. 15 shows spectrums of the output (1-bit pulse train) of the delta-sigma modulator 25, the RZ-coded output of the delta-sigma modulator 25, and the Manchester-coded output of the delta-sigma modulator 25. As seen from FIG. 15, in both the RZ coding and the Manchester coding, the spectrum is preserved by only performing frequency conversion (frequency shift).

However, while the output level is substantially the same at all frequencies in the RZ code, the DC component (frequency=0) disappears in the Manchester code. Thus, in the Manchester code, the low frequency component is suppressed while the high frequency component is emphasized, resulting in a V-shaped spectrum as a whole.

The reason seems to be as follows. In the Manchester code, 0 (Low) is converted into “01”, and 1 (High) is converted into “10”. Therefore, regardless of what kind of signal is output from the delta-sigma modulator 25, 0 and 1 (two types of bit values) occur with the same frequency, and therefore, the low frequency component including the DC component is reduced. Moreover, since the change between 0 and 1 occurs with high frequency, the high frequency component is increased.

In the RZ code, since 0 and 1 (two types of bit values) occur with different frequencies, the low frequency component is not suppressed in contrast to the Manchester code. In the RZ code, since the consecutive 0s increase as compared to before coding, the DC component increases.

As described above, the Manchester code is disadvantageous in that only a relatively small output is obtained on the low frequency side, and in this viewpoint, the RZ code is advantageous.

In order to output the Manchester code from the encoder 71, it is necessary to handle a signal of a higher frequency, and therefore, the signal conversion section 70 including the encoder 71 and the digital signal processing unit 21 need to operate at a higher speed as compared to the case of outputting the RZ code. On the other hand, when the RZ code is output from the encoder 71, since the signal conversion section 70 including the encoder 71 and the digital signal processing unit 21 may operate at a lower speed, the performance required of these sections and unit can be eased.

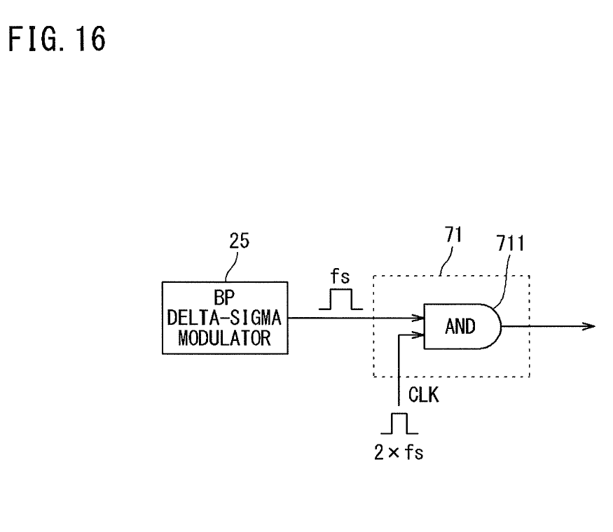

FIG. 16 shows an exemplary configuration of the encoder 71 performing the RZ coding process. In FIG. 16, the encoder 71 is configured as an AND circuit 711. An output (sampling frequency fs) of the delta-sigma modulator 25 and a clock (a rectangular pulse having a frequency twice the sampling frequency fs) are applied to inputs of the AND circuit 711. The clock may have a frequency n times (n is an integer not smaller than 2) the sampling frequency fs. By varying n, the amount of frequency conversion can be varied. The frequency of the clock is determined by the controller 35 in accordance with the frequency of the output of the delta-sigma modulator 25.

When the encoder 71 performs the Manchester coding process, an XOR circuit and a NOT circuit may be adopted instead of the AND circuit 711.

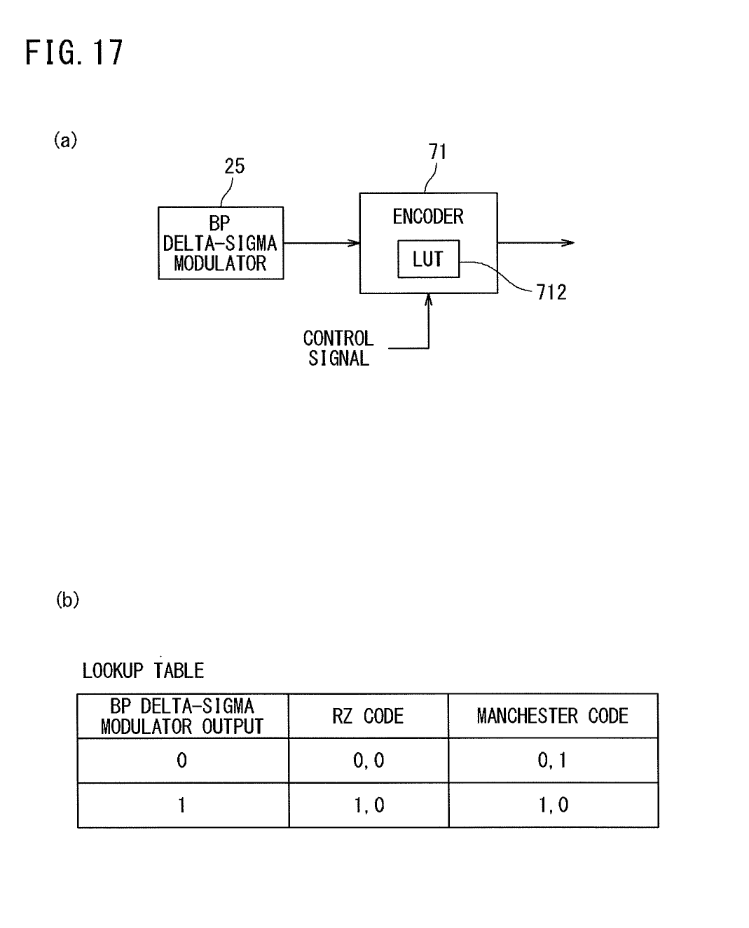

FIG. 17(a) shows another exemplary configuration of the encoder 71 performing the coding process. The encoder 71 of FIG. 17(a) includes a lookup table 712. Since the encoder 71 performs the coding process with reference to the lookup table 712, the processing speed can be increased as compared to the processing using the logic circuit (AND circuit).

As shown in FIG. 17(b), in the lookup table 712, line coded values corresponding to two kinds of bit values (0 and 1) in the output of the delta-sigma modulator 25 are defined. In the case of the RZ code, when the output of the delta-sigma modulator 25 is “0”, the RZ coded value is “00”, and when the output of the delta-sigma modulator 25 is “1”, the RZ coded value is “10”.

Not only the RZ coded values but also Manchester coded values are stored in the lookup table 712.

In the case of the Manchester code, when the output of the delta-sigma modulator 25 is “0”, the Manchester coded value is “01”, and when the output of the delta-sigma modulator 25 is “1”, the Manchester coded value is “10”.

Whether the encoder 71 refers to the RZ coded values or the Manchester coded values depends on a control signal from the controller 35.

The lookup table 712 may store only the RZ coded values. Alternately, the lookup table 712 may store only the Manchester coded values.

As described above, according to the Manchester code, the output is reduced on the low frequency side, whereas the large output can be obtained on the high frequency side. Accordingly, on the high frequency side, a larger output can be obtained by using the Manchester code rather than the RZ code. On the contrary, on the low frequency side, a larger output can be obtained by using the RZ code rather than the Manchester code.

Therefore, it is preferable to switch the coding process to be executed, depending on the frequency of the output signal. The controller 35 determines the frequency of the RF signal to be finally output, and determines, depending on the frequency, the type of the coding process to be executed by the encoder 71, and then provides the encoder 71 with a control signal indicating the type of the coding process. According to the control signal, the encoder 71 can switch the coding process to be executed.

When executing a plurality of coding processes by selectively switching between them, a plurality of kinds of coded values are defined in the lookup table 712 as shown in FIG. 17(b), whereby the encoder 71 can easily execute a plurality of different line coding processes.

For example, when a plurality of logic circuits (AND circuit and XOR circuit) corresponding to a plurality of coding processes are prepared to be used properly, the circuit scale is increased. In contrast, when a plurality of kinds of coded values are defined in the lookup table 712, the circuit configuration of the encoder 71 can be communalized although the content of the lookup table 712 varies depending on the coding processes.

The coded values defined in the lookup table 712 may be “10” for the output “0” of the delta-sigma modulator 25, and “01” for the output “1” of the delta-sigma modulator 25.

Alternatively, the coded values defined in the lookup table 712 may be “11” for the output “0” of the delta-sigma modulator 25, and “01” for the output “1” of the delta-sigma modulator 25.

Still alternatively, the coded values defined in the lookup table 712 may be “00” for the output “0” of the delta-sigma modulator 25, and “01” for the output “1” of the delta-sigma modulator 25.

Furthermore, the coded values defined in the lookup table 712 need not be 2-bit values, and may be values of 3 or more bits.

For example, the coded values defined in the lookup table 712 may be “0101” for the output “0” of the delta-sigma modulator 25, and “1010” for the output “1” of the delta-sigma modulator 25.

With any of these coded values, the coding process is frequency conversion for the RF signal.

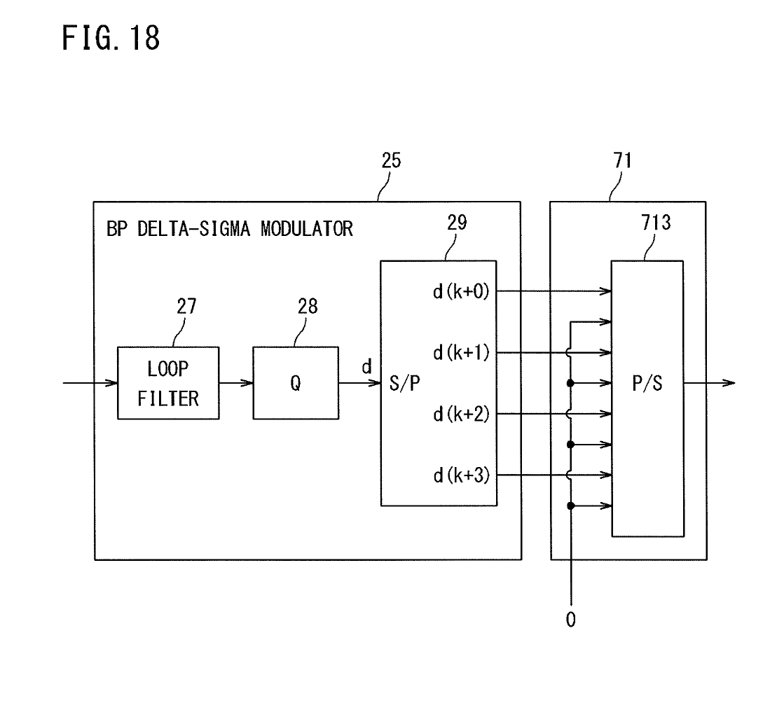

FIG. 18 shows other exemplary configurations of the delta-sigma modulator 25 and the encoder 71. In FIG. 18, the delta-sigma modulator 25 includes a serial-to-parallel converter 29 that converts a serial output (1-bit quantized signal) from the quantizer 28 into parallel outputs. The serial-to-parallel converter 29 shown in FIG. 18 performs conversion into 4-bit parallel signals. However, the number of bits of the parallel signal is not particularly limited, and 8-bit parallel signals may be output, for example.

The parallel-output 1-bit quantized signals each have a low signal rate, and therefore, can be easily handled.

While the delta-sigma modulator 25 is configured to perform parallel output by being provided with the serial-to-parallel converter 29, the quantizer 28 may be configured to output parallel quantized signals.

The parallel 1-bit quantized signals output from the delta-sigma modulator 25 are provided to the encoder 71.

The encoder 71 is configured to add, in parallel, a 0 signal to each of the parallel 1-bit quantized signals (4 bits) output from the delta-sigma modulator 25, and includes a parallel-to-serial converter 713 that converts the 8-bit parallel signals to which the 0 signals have been added, into a serial signal.

Adding the 0 signal in parallel in the encoder 71 corresponds to the RZ coding process in parallel. Since only adding the 0 signal is needed, the RZ coding process is easily performed.

Then, the 8-bit parallel signals having been subjected to the parallel RZ coding process are converted into a serial signal by the parallel-to-serial converter 713, thereby obtaining a serial 1-bit quantized signal having been subjected to the coding process.

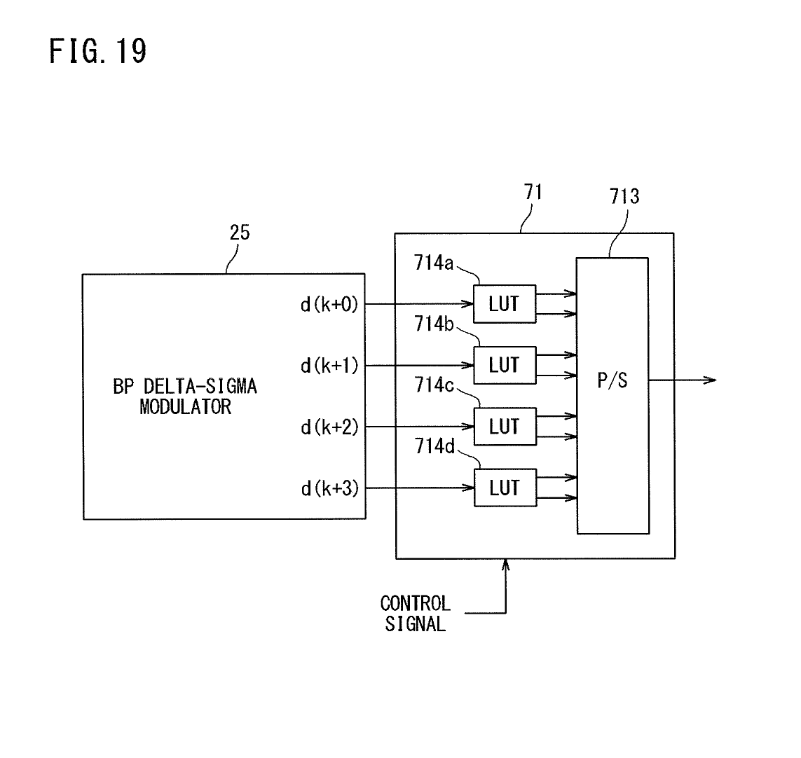

FIG. 19 shows still another exemplary configuration of the encoder 71. The delta-sigma modulator 25 shown in FIG. 19 is configured to output 1-bit quantized signals in parallel, like the delta-sigma modulator 25 shown in FIG. 18.

The encoder 71 shown in FIG. 19 includes the parallel-to-serial converter 713 like the encoder 71 shown in FIG. 18, and further includes lookup tables 714a to 714d. Each of the lookup tables 714a to 714d is identical to the lookup table 712 shown in FIG. 17.

The encoder 71 performs the coding process upon determining, according to a control signal from the controller 35, which of the RZ coded values and the Manchester coded values in the lookup tables 714a to 714d are to be referred to. By the coding process with reference to the lookup tables 714a to 714d for the respective parallel signals, the 4-bit parallel 1-bit quantized signals are converted into 8-bit parallel signals. The 8-bit parallel signals are converted into a serial signal by the parallel-to-serial converter 713, and thus the serial 1-bit quantized signal having been subjected to the coding process is obtained.

By performing the coding process on the parallel signals, the coding process performed with reference to the lookup tables 714a to 714d can be advantageously performed at a low rate.

[5. Additional Notes]

The embodiment disclosed herein is merely illustrative in all aspects and should not be recognized as being restrictive. The scope of the present invention is defined by the scope of the claims rather than by the meaning described above, and is intended to include meaning equivalent to the scope of the claims and all modifications within the scope.

### REFERENCE SIGNS LIST

1 system
25 delta-sigma modulator (converter)
32 analog filter
70 signal conversion device
71 encoder
712 lookup table
713 parallel-to-serial converter

1. A signal conversion device comprising:
a converter configured to output a 1-bit quantized signal representing an analog signal based on a band transmission system; and
an encoder configured to execute a baseband line coding process on the 1-bit quantized signal, wherein
the baseband line coding process is a process to be frequency conversion for the analog signal, and is a baseband line coding process in which the 1-bit quantized signal is coded such that the appearance frequencies of two kinds of bit values in the 1-bit quantized signal are different from each other.

2. The signal conversion device according to claim 1, wherein
the encoder is able to execute a first baseband line coding process on the 1-bit quantized signal and a second baseband line coding process on the 1-bit quantized signal by selectively switching between these coding processes,
the first baseband line coding process is a process to be frequency conversion for the analog signal, and is a baseband line coding process in which the 1-bit quantized signal is coded such that the appearance frequencies of two kinds of bit values in the 1-bit quantized signal are different from each other, and
the second baseband line coding process is a process to be frequency conversion for the analog signal, and is a baseband line coding process in which the 1-bit quantized signal is coded such that the appearance frequencies of two kinds of bit values in the 1-bit quantized signal are equal to each other.

3. The signal conversion device according to claim 2, wherein the encoder executes the first baseband line coding process and the second baseband line coding process by selectively switching between these coding processes in accordance with the frequency of the analog signal.

4. The signal conversion device according to claim 2, wherein the first baseband line coding process is an RZ coding process.

5. The signal conversion device according to claim 2, wherein the second baseband line coding process is a Manchester coding process.

6. The signal conversion device according to claim 1, wherein the encoder includes a lookup table in which a line coded value corresponding to each of the two kinds of bit values in the 1-bit quantized signal is defined, and executes the baseband line coding process based on the lookup table.

7. The signal conversion device according to claim 1, wherein
the converter is configured to output the 1-bit quantized signal in parallel, and
the encoder is configured to execute a baseband line coding process on the parallel 1-bit quantized signal, and includes a parallel-to-serial converter configured to convert the parallel signal having been subjected to the baseband line coding process into a serial signal, and output the serial signal.

8. The signal conversion device according to claim 7, wherein
the encoder includes a lookup table in which a line coded value corresponding to each of the two kinds of bit values in the 1-bit quantized signal is defined,
in the lookup table, a plurality of line coded values are defined corresponding to each of the two kinds of bit values in the 1-bit quantized signal, and
the encoder selects one of the plurality of line coded values defined corresponding to each of the two kinds of bit values in the 1-bit quantized signal to execute the baseband line coding process.

9. A signal conversion device comprising:
a converter configured to output a 1-bit quantized signal representing an analog signal based on a band transmission system; and
an encoder configured to execute a baseband line coding process on the 1-bit quantized signal, wherein
the encoder includes a lookup table in which a line coded value corresponding to each of two kinds of bit values in the 1-bit quantized signal is defined, and executes the baseband line coding process, based on the lookup table.

10. A signal conversion device comprising:
a converter configured to output a 1-bit quantized signal representing an analog signal based on a band transmission system; and
an encoder configured to execute a baseband line coding process on the 1-bit quantized signal, wherein
the converter is configured to output the 1-bit quantized signal in parallel, and
the encoder is configured to execute the baseband line coding process on the parallel 1-bit quantized signal, and includes a parallel-to-serial converter configured to convert the parallel signal having been subjected to the baseband line coding process into a serial signal, and output the serial signal.

11. The signal conversion device according to claim 10, wherein
the encoder includes a lookup table in which a line coded value corresponding to each of the two kinds of bit values in the 1-bit quantized signal is defined,
in the lookup table, a plurality of line coded values are defined corresponding to each of the two kinds of bit values in the 1-bit quantized signal, and
the encoder selects one of the plurality of line coded values defined corresponding to each of the two kinds of bit values in the 1-bit quantized signal to execute the baseband line coding process.

12. A transmitter including the signal conversion device according to claim 1, and configured to transmit the 1-bit quantized signal having been subjected to the baseband line coding process.
